(19) United States
(12) Patent Application Publication
(10) Pub. No.: US 2011/0223432 A1
(43) Pub. Date: Sep. 15, 2011

(54) SILICONE BLANKET OF MULTILAYER STRUCTURE FOR MICRO PATTERN OFFSET PRINTING

(75) Inventors: Bum Suk Ro, Gunpo-si (KR); Hwa Joong Kim, Seoul (KR); Jun Gyu Lee, Daegu (KR)

(73) Assignee: SSCP CO., LTD., Ansan-si (KR)

(21) Appl. No.: 13/113,556

(22) Filed: May 23, 2011

Related U.S. Application Data
(63) Continuation of application No. PCT/KR2009/006924, filed on Nov. 24, 2009.

(30) Foreign Application Priority Data
Nov. 24, 2008 (KR) 10-2008-0117013

(51) Int. Cl. B32B 9/04

(52) U.S. Cl. 428/447

(57) ABSTRACT

Provided is a silicon blanket for a micro pattern offset printing that includes a first layer wherein the solvent absorption rate has been enhanced by elevating the proportion of low vinyl polysiloxane and adding silicon gum; and a second layer wherein the mechanical strength has been enhanced by elevating the content of high vinyl polysiloxane; thus, increasing the lifetime and initial printing quality.

### CROSS-REFERENCE TO RELATED APPLICATION(S)

This application claims the benefit under 35 U.S.C. §120 of International Patent Application No. PCT/KR2009/006924, filed on Nov. 24, 2009, the entire disclosure of which is incorporated herein by reference for all purposes.

### TECHNICAL FIELD

The following description relates to a silicon blanket for a micro pattern offset printing.

### BACKGROUND ART

Generally, an offset printing is an indirect printing method. In the offset printing, a paint image is transferred from a pattern roll or plate to a surface of a rubber plate of a blanket, and the paint image on the blanket is again transferred to a material to be printed. Thus, the image of the offset printing plate is the same as an original image, the image on the blanket is the contrary to the original image, and the image of the printed material is the same as the original image. At the offset printing, the paint on the pattern roll or plate is first transferred to the blanket, which is referred to as off, and the paint on the blanket is next transferred to the material to be printed, which is referred to as set.

Here, when the paint is on the blanket, a solvent of the paint permeates into the rubber plate of the blanket in a small quantity, and it causes swelling of the rubber plate of the blanket. As a number of the printing increases, the swelling of the rubber plate of the blanket also increases. When the swelling does not occur anymore and the paint on the blanket is not transferred at the set step, the lifetime of the rubber plate of the blanket comes to an end.

Various synthetic rubbers are used for the rubber blanket for the offset printing. Typically, a styrene butadiene rubber, an acrylonitrile butadiene rubber, a butyl rubber, an ethylene-propylene diene rubber, a polybutadiene rubber, a polychloroprene rubber, a polyisoprene rubber, and a silicon rubber may be used.

However, when the printing is carried out by the conventional rubber blanket for the offset printing, a printing quality is not excellent and a micro pattern cannot be printed due to various conditions. Particularly, if a saturation swelling ratio of the silicon blanket increases in order to increase a lifetime, an initial printing quality is reduced. It is because an initial swelling ratio is largely increased and thus the paint is partially dried at the set process. Also, a viscosity of the paint may be increased during the printing due to the high swelling ratio, and thus a lot of bumps may be generated at the result product.

### SUMMARY

The following description provides a silicon blanket for a micro pattern offset printing having an extended lifetime and having an excellent initial printing quality.

To achieve the above, the following description provides a silicon blanket of a multilayer structure for a micro pattern offset printing. The silicon blanket includes a first layer and a second layer.

The first layer is manufactured by curing a first composition, and the first composition includes 50 to 90 wt % of a polysiloxane including a high vinyl polysiloxane and a low vinyl polysiloxane with a mixing weight ratio of 0.5:1 to 2:1. The first composition further includes 10 to 50 parts by weight of a silcon gum based on 100 parts by weight of the polysiloxane.

The second layer is manufactured by curing a second composition, and the second composition includes 50 to 90 wt % of a polysiloxane including a high vinyl polysiloxane and a low vinyl polysiloxane with a mixing weight ratio of 2:1 to 15:1.

Also, the following description provides a silicon blanket of a multilayer structure that a swelling ratio of a first layer to a butyl cellusolve (BC) solvent is larger than that of a second layer to the BC solvent. A swelling property is evaluated through a weight variation while the silicon blanket cut to have an area of 10×10 cm is in contact at 25° C. with the BC solvent having a high boiling point for 30 minutes. The swelling ratio of the first layer to the BC solvent is 10 to 40%, and the swelling ratio of the second layer to the BC solvent is 1 to 11%.

### BRIEF DESCRIPTION OF DRAWINGS

FIG. 1 and FIG. 2 illustrate a fine pattern shape that is printed by an offset printing using a blanket according to Comparative Example 1 and Embodiment 3, respectively.

### DESCRIPTION

A silicon blanket for a micro pattern offset printing according to the following description includes a first layer having a high swelling ratio and a good adhesion property and a second layer having a relatively low swelling ratio and a good mechanical property. Thus, a printing property at the offset printing and a lifetime of the blanket can be increased, and a printing quality can be improved by suppressing a rapid increase of an initial swelling velocity.

A silicon blanket of a multilayer structure for a micro pattern offset printing includes a first layer and a second layer.

The first layer is a layer for storing a solvent, and has a high swelling ratio. Preferably, the first layer has a swelling ratio of 10% or more to a butyl cellusolve (BC) solvent. Preferably, the swelling ratio of the first layer to the BC solvent may be 10 to 40%. Here, the swelling property is evaluated through a weight variation while the silicon blanket cut to have an area of 10×10 cm is in contact at 25° C. with the BC solvent having a high boiling point for 30 minutes.

However, a lifetime of the blanket increases when the blanket has the high swelling ratio, but an initial swelling velocity is high and more solvent than necessary is absorbed to the blanket, thereby reducing a printing quality. In order to remedy the above weak point, the second layer is included.

The second layer has a high mechanical property instead of having the relatively low swelling ratio. Thus, the second layer can prevent the fall of the initial printing quality and counteract lots of contacts between a gravure pattern roll and a glass substrate. Preferably, the solvent swelling ratio of the second layer to the BC solvent may be 11% or less, and particularly, 1 to 11%. Specifically, a thickness of the second layer having the low swelling ratio affects to the lifetime of the silicon blanket. Thus, within the range that the mechanical property is allowable, as the second layer gets thinner, it becomes better. Accordingly, in order to be able to coat with a small thickness, a composition having a low viscosity for the second layer may be used.

Preferably, the first layer may have a thickness of 250 to 1250 μm, considering the swelling property and the pattern transfer property. Because the first layer acts as the layer for storing the solvent, it is preferable that the first layer has a thickness larger than that of the second layer. The second layer should have a mechanical property and a swelling property (that is, a function delivering the absorbed solvent to the first layer). Considering the above, the second layer preferably has a thickness of 50 to 150 μm.

Also, the silicon blanket may have a total thickness of 400 to 1300 μm considering the transfer property and the mechanical property.

Because the silicon blanket of the multilayer structure has the above structural characteristic, the swelling property can be increased, and thus the releasability is more efficient. The silicon blanket is applied to the offset printing where a delicate fine pattern is needed, and the lifetime of the blanket rubber can be largely increased. When the silicon blanket having an efficient releasability and a increased lifetime is applied to a photolithography process where a delicate fine pattern is needed, a photo resist wasted at the photolithography process can be reused. Accordingly, a production time can be shortened and a cost can be reduced through eliminating a drying facility. Thus, the productivity can be largely improved.

The first and second layers of the silicon blanket of the multilayer structure according to the following description are formed by curing different first and second compositions, respectively. Here, the curing method is a heat curing method or a UV curing method.

Hereinafter, each of components of the compositions according to the following description will be descried in detain.

### Polysiloxane

A high vinyl polysiloxane decreases a viscosity and increases hardness. The high vinyl polysiloxane used has a vinyl group content of about 0.1 to 0.4 mmol/g, and has a viscosity of about 200 to 2,000 cPs at 25° C. when measured by a Brookfield Viscometer. The high vinyl polysiloxane may be represented by following Chemical Formula 1.

R¹ₐSiO_{(4-a)/2} <Chemical Formula 1>

Here, R¹ is a C₂-C₁₀ alkenyl group, and a is a positive number of about 1.9 to 2.05.

A low vinyl polysiloxane increases a viscosity and a swelling ratio. The low vinyl polysiloxane used for the present invention has a vinyl group content of about 0.01 to 0.1 mmol/g, and has a viscosity of about 2,000 to 200,000 cPs at 25° C. when measured by a Brookfield Viscometer. The low vinyl polysiloxane may be represented by following Chemical Formula 2.

R²_{b}SiO_{(8-b)/2} <Chemical Formula 2>

Here, R² is a C₂-C₁₀ alkenyl group, and b is a positive number of about 1.2 to 4.8.

Preferably, the first or second composition for manufacturing the first or second layer of the silicon blanket may include 50 to 90 wt % of the polysiloxane based on the total weight of each composition.

Here, in the first composition, the polysiloxane may include the high vinyl polysiloxane and the low vinyl polysiloxane with a mixing weight ratio of 0.5:1 to 2:1 in order to obtain the sufficient swelling property. In the second composition, the polysiloxane may include the high vinyl polysiloxane and the low vinyl polysiloxane with a mixing weight ratio of 2:1 to 15:1 in order to obtain the relatively low swelling ratio and viscosity and to have a good mechanical property.

### Polysiloxane Hydride

A polysiloxane hydride acts as a binder. The polysiloxane hydride is activated by a catalyst and makes n bonds of vinyl polysiloxane be unstable, thereby bonding them. The polysiloxane hydride may have a weight-average molecular weight of about 1,000 to 10,000. The polysiloxane hydride may be represented by following Chemical Formula 3.

R³_{c}SiO_{(4-c)/2} <Chemical Formula 3>

Here, R³ is a C₁-C₁₀ alkyl group having one or two hydride groups at both ends, and c is a positive number of about 1.90 to 2.05.

The polysiloxane hydride polymer may be included in an amount of 10 to 25 parts by weight based on 100 parts by weight of the polysiloxane. When the amount is below 10 parts by weight, a crosslinking density is low, and the curing may be not performed well or the surface stickness may be generated. When the amount is above 25 parts by weight, crosslinked polymer chains have a small length and the physical property is decreased. By the similar reason, a number ratio of a vinyl group and a hydride group may be 1:1 to 1:4.

### Silicon Gum

A silicon gum is added to further increase the swelling ratio of the blanket. The silicon gum may be a polysiloxane compound having a viscosity of about 1,000 to 5,000,000 cPs at 25° C. when measured by a Brookfield Viscometer and having a large molecular weight.

Also, it is preferable to use the silicon gum manufactured to have a functionality by changing an organic group of side chains of siloxane. The silicon gum can be classified by a substituted group. For example, the organic group may be a methyl group, a vinyl group, a phenyl group, an ethoxy group, an ester group, an acrylic group, a urethane group, and so one. On the other hand, in ASTM, the silicon gum is classified by a methyl group, and it may be used for forming (molding), super low temperature, permanent low compression shrink, high tear and strength, oil resistance, or a food.

The silicon gum may be included in an amount of about 10 to 50 parts by weight based on 100 parts by weight of the polysiloxane. When the amount is above 50 parts by weight, it is difficult to manufacture the silicon rubber blanket due to the high viscosity.

### Platinum Catalyst

A platinum catalyst is added as a powder shape for activating the curing reaction at the manufacturing process. The platinum catalyst may be included in an amount of about 5 to 50 weight ppm based on 100 parts by weight of the composition. When the amount is below 5 weight ppm, the curing may be not performed well at a high temperature. When the amount is above 50 weight ppm, the curing may be generated at a room temperature.

### Polymerization Inhibitor

A polymerization inhibitor is used for preventing a rapid curing of the composition at the room temperature, which may be generated due to a high reactivity of the added platinum catalyst. The polymerization inhibitor may be a material that is conventionally used. For example, the polymerization inhibitor may be a material including a methyl group, a vinyl group, or a phenyl group such 2,6-di-tert-butyl-4-methyl-phenol, a methanol, a methane sulphonic acid, a formic acid, or a phosphoric acid, but the following description is not limited thereto. The polymerization inhibitor may be preferably included in an amount of about 0.5 to 2 parts by weight based on 100 parts by weight of the composition. When the amount is above 2 parts by weight, the curing may be not performed well at a high temperature.

The silicon blanket rubber composition including the above components is formed as one of a bulk molding compound (BMC) type and a sheet molding compound (SMC) type.

At the BMC type, a paste state manufactured by mixing and stirring the composition is injected into an inside of a mold as or is placed at a lower side of the inside of the mold during a compression molding. For example, the composition is pressed at a temperature 50 to 160° C. under a pressure of 50 to 160 kg/cm² for some time to have a predetermined thickness, and is cured by a heat curing or a UV curing. Then, a thermosetting synthetic resin molding having a wanted shape (that is, silicon blanket) is produced.

The SMC type is manufactured by packing the mixed and stirred composition with a protection film and aging for a predetermined time. The SMC type has a high viscosity by the added silicon gum and has a sheet type of a solid. Thus, the SMC type is cut to have a proper size after removing the protection film, and is inserted to an inside of a mold. For example, the mold where the SMC type is inserted is pressed at a temperature 50 to 160° C. under a pressure of 50 to 160 kg/cm² for some time to have a predetermined thickness, and is cured by a heat curing or a UV curing. Then, a thermosetting synthetic resin molding having a wanted shape (that is, silicon blanket) is produced.

The silicon blanket of the multilayer structure may be formed by repeating the above coating and curing processes. That is, after the first layer is manufactured by coating the first composition and curing the same, the second layer is manufactured by coating the second composition on the first layer and curing the same.

Next, the following Embodiments are only examples, and the examples described herein are not limited thereto.

### Preparation of Materials

Materials used for Manufacturing Embodiments are prepared as follows.

1) a high vinyl polysiloxane: AB109358 made by ABCR chemical, a viscosity=800 cPs at 25° C., a vinyl content=0.1 mmol/g, a structural formula−R¹ₐSiO_{(4-a)/2} (R¹=C₃ alkenyl, a=2.1)

2) a low vinyl polysiloxane: AB109361 made by ABCR chemical, a viscosity=120,000 cPs at 25° C., a vinyl content=0.03 mmol/g, a structural formula −R²_{b}SiO_{(8-b)/2} (R²=C₉ alkenyl, b=3.3)

3) a polysiloxane hydride: AB109365 made by ABCR chemical, Mw=2,000, a hydride content=2.1 mmol/g, a structural formula −R³_{c}SiO_{(4-c)/2} (R³=C₃ alkyl, c=1.95)

4) a silicon gum: AB109409 made by ABCR chemical, a vinyl content=0.1 mmol/g, a viscosity of 80,000 cPs at 25° C.,

5) a polymerization inhibitor: AB108801 made by ABCR chemical

6) a platinum catalyst: AB121421 made by ABCR chemical, a purity: 80-81%

### Manufacturing For Silicon Rubber Composition

### Manufacturing Embodiments 1-1 To 1-3: Manufacturing For A Silicon Rubber Composition For A First Layer

The high vinyl polysiloxane and the low vinyl polysiloxane were added to a container with 250 ml. And then, they were stirred at an agitator (Dispermat) with 2000 rpm for about 10 minutes. And then, a polysiloxane hydride and a polymerization inhibitor were added and stirred with 2000 rpm for about 10 minutes. Sequentially, the silicon gum including the vinyl group was added and stirred with 2000 rpm for about 10 minutes. Next, the platinum catalyst was added and mixed at an ARE-250 mixer for 5 minutes, and is defoamed for 5 minutes. Therefore, various liquid silicon rubber compositions were manufactured as shown in Table 1. (unit: g)

TABLE 1

| | Manufacturing | Manufacturing | Manufacturing |
|---|---|---|---|
| | Embodiment | Embodiment | Embodiment |
| Ingredient | 1-1 | 1-2 | 1-3 |
| high vinyl polysiloxane | 35 | 35 | 35 |
| low vinyl polysiloxane | 45 | 35 | 25 |
| polysiloxane hydride | 10 | 10 | 10 |
| silicon gum including a | 10 | 20 | 30 |
| vinyl group | | | |
| polymerization | 1 | 1 | 1 |
| inhibitor | | | |
| platinum catalyst | 0.001 | 0.001 | 0.001 |
| (Si—H)/(vinyl group) | 2.13 | 2.12 | 2.10 |
| ratio | | | |

### Manufacturing Embodiment 2-1 To 2-4: Manufacturing For A Silicon Rubber Composition For A Second Layer

The various liquid silicon rubber compositions were manufactured as shown in Table 2 by the same method as in Manufacturing Embodiments 1-1 to 1-3 except that the silicon gum was not added. (unit: g)

TABLE 2

| | Manufac- | Manufac- | Manufac- | Manufac- |
|---|---|---|---|---|
| | turing | turing | turing | turing |
| | Embodiment | Embodiment | Embodiment | Embodiment |
| Ingredient | 2-1 | 2-2 | 2-3 | 2-4 |
| high vinyl | 60 | 55 | 50 | 45 |
| polysiloxane | | | | |
| low vinyl | 5 | 10 | 15 | 20 |
| polysiloxane | | | | |
| polysiloxane | 10 | 10 | 10 | 10 |
| hydride | | | | |
| polymerization | 1 | 1 | 1 | 1 |
| inhibitor | | | | |
| platinum | 0.001 | 0.001 | 0.001 | 0.001 |
| catalyst | | | | |
| (Si—H)/(vinyl | 1.8 | 1.9 | 1.96 | 2.00 |
| group) ratio | | | | |

### Manufacture For Silicon Blanket

### Comparative Example 1

### Conventional Manufacturing For A Silicon Blanket

The silicon rubber composition manufactured at Manufacturing Embodiment 2-4 was coated on one surface of polyethylene (PET) film using an applicator with a thickness of 900 μm. And then, it was defoamed at a convection oven of 70° C. for 10 minutes and was cured at a convection oven of 150° C. for 20 minutes. Therefore, the silicon blanket was manufactured.

### Embodiments 1 to 3: Manufacturing For A Silicon Blanket Of A Multilayer Structure

The compositions according to Manufacturing Embodiments 1-1 to 1-3 were cured as in Comparative Example 1. Thus, the blanket of the first layer was manufactured. The silicon composition for the second layer was coated on the first layer and was cured as in the similar method. Thus, the silicon blankets of various multilayer structures were manufactured as shown in FIG. 3. The first layer was manufactured to have a thickness of 580μm, and the second layer was manufactured to have a thickness of 70μm.

TABLE 3

| | Embodiment 1 | Embodiment 2 | Embodiment 3 |
|---|---|---|---|
| First | Manufacturing | Manufacturing | Manufacturing |
| layer | Embodiment 1-1 | Embodiment 1-2 | Embodiment 1-3 |
| Second | Manufacturing | Manufacturing | Manufacturing |
| layer | Embodiment 2-1 | Embodiment 2-1 | Embodiment 2-1 |

### Experimental Embodiment

### Experimental Embodiment 1

### Property Evaluation of Each Layer

The silicon rubber compositions manufactured at Manufacturing Embodiments 1-1 to 2-4 were cured as in Comparative Example 1 to manufacture the silicon blankets, respectively.

The properties are measured by methods as follows.

1) An evaluation of a swelling property to a solvent—The swelling property was evaluated through a weight variation while the silicon blanket cut to have an area of 10×10 cm is in contact at 25° C. with the BC solvent having a high boiling point for 30 minutes.

2) A measurement of a tensile strength—Each of the silicon blankets was cut into 1 cm. And, the tensile strength of the cut silicon blankets was measured by a universal testing machine (UTM) (4433 model made by Instron).

3) A measurement of hardness—The hardness was measured by HH-336 (Type A) made by Mitutoyo.

4) A measurement of a viscosity—With respect to each of the silicon rubber compositions manufactured at Manufacturing Embodiments 1-1 to 2-4, the viscosity was measured by using Brookfield RVDVΠ+at 25° C.

The results are shown in Tables 4 and 5.

TABLE 4

| | Manufacturing | Manufacturing | Manufacturing |
|---|---|---|---|
| | Embodiment | Embodiment | Embodiment |
| | 1-1 | 1-2 | 1-3 |
| BC swelling (%) | 11.5 | 12.5 | 14.0 |
| Tensile strength | 0.25 | 0.23 | 0.20 |
| (kgf/mm²) | | | |
| Hardness (shore A) | 16 | 14 | 14 |
| Viscosity (cPs) | 9548 | 8784 | 9341 |

As shown in Table 4, in Manufacturing Embodiment 1-3 where the silicon gum content having the vinyl group was included in a relatively large amount, the silicon blanket had the excellent swelling property and could absorb the solvent with the largest amount. Thus, the silicon rubber composition according to Manufacturing Embodiment 1-3 was the most proper to the first layer.

TABLE 5

| | Manufac- | Manufac- | Manufac- | Manufac- |
|---|---|---|---|---|
| | turing | turing | turing | turing |
| | Embodiment | Embodiment | Embodiment | Embodiment |
| | 2-1 | 2-2 | 2-3 | 2-4 |
| BC swelling | 7.5 | 7.7 | 7.7 | 7.9 |
| (%) | | | | |
| Tensile | 0.28 | 0.27 | 0.25 | 0.23 |
| strength | | | | |
| (kgf/mm²) | | | | |
| Hardness | 25 | 25 | 25 | 25 |
| (shore A) | | | | |
| Viscosity | 3578 | 4356 | 5230 | 6874 |
| (cPs) | | | | |

As shown in Table 5, the silicon blanket of Manufacturing Embodiment 2-1 had the relatively low swelling ratio, the most superior tensile strength, and the lowest viscosity, thereby being able to coating with a small thickness. Accordingly, the silicon rubber composition according to Manufacturing Embodiment 2-1 was the most proper to the second layer.

### Experimental Embodiment 2

### Evaluation of An Initial Printing Quality

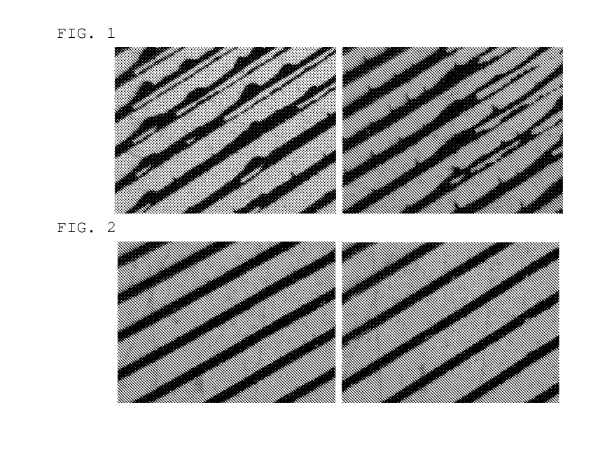

The offset printing of a black strip was performed by using the silicon blankets according to Comparative Example 1 and Embodiment 3, and thus fine patterns were formed on a printing paper. The results at the fifth printing are shown FIGS. 1 and 2, respectively. From FIGS. 1 and 2, it could be seen that the fine pattern printings of good quality were obtained when using the silicon blanket of Embodiment 3 of the present invention (FIG. 2), but the printing state was bad (that is, the shapes of fine patterns were not uniform and the bump are generated) when using the silicon blanket of Comparative Example 1 (FIG. 1).

### Experimental Embodiment 3

### Lifetime Evaluation of A Silicon Blanket

A screen printing plate and a generally used ink were used. The ink was transferred to the cured silicon blanket rubber and was left for one minute. And then, after a PET film was on the silicon blanket rubber, 1 kg of a hand roller was reciprocated one time. The numbers were measured when the ink was not transferred from the blanket to the PET film by 100%. The results are shown in Table 6.

TABLE 6

| | Comparative | | | |
|---|---|---|---|---|
| | Example | Embodiment | Embodiment | Embodiment |
| | 1 | 1 | 2 | 3 |
| Effective | 68 | 112 | 123 | 149 |
| printing | | | | |
| numbers | | | | |

As shown in the above Table 6, the silicon blankets of the multilayer structures (Embodiments 1 to 3) have a superior lifetime property than that of conventional silicon blanket (Comparative Example 1). Particularly, the silicon blanket according to Embodiment 3 using compositions of Manufacturing Embodiment 1-3 and 2-1 has the most superior lifetime property.

Although the following description has been described with reference to a number of embodiments thereof, it should be understood that numerous other modifications and embodiments can be devised by those skilled in the art that will fall within the spirit and scope of the principles of the appended claims.

According to a silicon blanket for a micro pattern offset printing, a printing property at the offset printing and a lifetime of the blanket can be increased, and a printing quality can be improved by preventing a rapid increase of an initial swelling velocity. Thus, the present invention is industrially useful.

1. A silicon blanket of a multilayer structure for a micro pattern offset printing, the silicon blanket comprising:
a first layer manufactured by curing a first composition, wherein the first composition comprising 50 to 90 wt % of a polysiloxane, the polysiloxane comprising a high vinyl polysiloxane and a low vinyl polysiloxane with a mixing weight ratio of 0.5:1 to 2:1, the first composition further comprising 10 to 50 parts by weight of a silcon gum based on 100 parts by weight of the polysiloxane; and
a second layer manufactured by curing a second composition, wherein the second composition comprising 50 to 90 wt % of a polysiloxane, the polysiloxane comprising a high vinyl polysiloxane and a low vinyl polysiloxane with a mixing weight ratio of 2:1 to 15:1.

2. The silicon blanket of claim 1, wherein the high vinyl polysiloxane has a vinyl group content of 0.1 to 0.4 mmol/g, and the low vinyl polysiloxane has a vinyl group content of 0.01 to 0.1 mmol/g.

3. The silicon blanket of claim 1, wherein the high vinyl polysiloxane has a viscosity of 200 to 2,000 cPs at 25° C., and the low vinyl polysiloxane has a viscosity of 2,000 to 200,000 cPs at 25° C.

4. The silicon blanket of claim 1, wherein the silicon gum has a viscosity of 1,000 to 5,000,000 cPs at 25° C.

5. The silicon blanket of claim 1, wherein the silicon gum comprises at least one organic group selected from a group consisting of a methyl group, a vinyl group, a phenyl group, an ethoxy group, an ester group, an acrylic group, and a urethane group.

6. The silicon blanket of claim 1, wherein at least one of the first composition and the second composition further comprises 10 to 25 parts by weight of a polisiloxane hydride based on 100 parts by weight of the polysiloxane.

7. The silicon blanket of claim 6, wherein at least one of the first composition and the second composition comprises a vinyl group and a hydride group with a number ratio of 1:1 to 1:4.

8. The silicon blanket of claim 1, wherein the high vinyl polysiloxane and the low vinyl polysiloxane are respectively represented by following Chemical Formula 1 and Chemical Formula 2:
R¹ₐSiO_{(4-a)/2} <Chemical Formula 1>
wherein, R¹ is a C₂-C₁₀ alkenyl group, and a is a positive number of 1.9 to 2.05;
R²_{b}SiO_{(8-b)/2} <Chemical Formula 2>
wherein, R² is a C₂-C₁₀ alkenyl group, and b is a positive number of 1.2 to 4.8.

9. The silicon blanket of claim 6, wherein the polysiloxane hydride is represented by following Chemical Formula 3:
R³_{c}SiO_{(4-c)/2} <Chemical Formula 3>
wherein, R³ is a C₁-C₁₀ alkyl group having the hydride group at both ends, and c is a positive number of 1.9 to 2.05.

10. The silicon blanket of claim 6, wherein the polysiloxane hydride has a weight-average molecular weight of 1,000 to 10,000.

11. The silicon blanket of claim 1, wherein the curing method is a heat curing method or a UV curing method.

12. The silicon blanket of claim 1, wherein the first layer has a thickness of 250 to 1250 μm, and the second layer has a thickness of 50 to 150 μm.

13. A silicon blanket of a multilayer structure comprising a swelling ratio of a first layer to a butyl cellusolve (BC) solvent being larger than that of a second layer to the BC solvent,
wherein a swelling property is evaluated through a weight variation while the silicon blanket cut to have an area of 10×10 cm is in contact at 25° C. with the BC solvent having a high boiling point for 30 minutes, and
wherein the swelling ratio of the first layer to the BC solvent is 10 to 40%, and the swelling ratio of the second layer to the BC solvent is 1 to 11%.

14. The silicon blanket of claim 13, wherein the first layer and the second layer have a characteristic of one of claims 1 to 12.
